(19) United States
(12) Patent Application Publication
(10) Pub. No.: US 2015/0021351 A1
(43) Pub. Date: Jan. 22, 2015

(54) Pedometer Dispenser

(71) Applicant: Michael Kaneko, Walnut, CA (US)

(72) Inventor: Michael Kaneko, Walnut, CA (US)

(21) Appl. No.: 13/944,360

(22) Filed: Jul. 17, 2013

(51) Int. Cl. A47K 10/42; G01C 22/00

(52) U.S. Cl. CPC A47K 10/426; G01C 22/006
USPC 221/45

(57) ABSTRACT

A pedometer dispenser includes a housing having a frame with a pedometer mounted to the frame and a recess formed on the frame. A dispenser door is mounted to the frame, and the dispenser door covers the recess. The dispenser door has an opening formed on a surface of the dispenser door. A dispenser is retained within the recess. The dispenser occupies a rear portion of the frame and the pedometer occupies at least a portion of a front portion of the frame. The pedometer dispenser is bounded between the dispenser door and the pedometer. The pedometer preferably also includes a latch connected to the frame.

### DISCUSSION OF RELATED ART

A variety of different leash accessories attach to a leash or a user for walking a dog or other pet. Pedometers have been used by dog walkers, joggers and runners for counting steps and monitoring physical activity. A variety of different designs for pedometers have been presented in patent publications.

### SUMMARY OF THE INVENTION

The invention includes a pedometer and a bag dispenser in a unitary housing. The pedometer is located on a front portion of the housing and a bag dispenser is located on a rear portion of the housing. Adjacent to the pedometer is a fluid vial for carrying hand sanitizer. The fluid vial is preferably located below the pedometer.

The pedometer is preferably an electronic circuit counting steps that a user takes while on a walk. The pedometer has a reset button for resetting the step count. The pedometer also may have a sensitivity adjustment for controlling the sensitivity of the step sensor. The step sensor can be an inertia switch activated when a user takes a step. The pedometer preferably also includes a power button that turns on the power. The pedometer may turn off automatically after a certain time of inactivity.

A pedometer dispenser includes a housing having a frame with a pedometer mounted to the frame and a recess formed on the frame. A dispenser door is mounted to the frame, and the dispenser door covers the recess. The dispenser door has an opening formed on a surface of the dispenser door. A dispenser is retained within the recess. The dispenser occupies a rear portion of the frame and the pedometer occupies at least a portion of a front portion of the frame. The pedometer dispenser is bounded between the dispenser door and the pedometer. The pedometer preferably also includes a latch connected to the frame.

The latch is configured to latch onto the dispenser door to form a latch connection between the frame and the dispenser door. A swivel connection is formed between the frame and the dispenser door. The pedometer may also have a recess sidewall extending from the frame. Preferably, the recess sidewall bounds the recess. A battery door can allow for accessing the pedometer, especially when the battery door is located within the recess. A flask can be slidingly mounted to the frame, and the flask can be configured to hold a liquid or gel. The flask can be removed from the frame, and the flask has a flask lid that attaches to the flask. The flask has a rectangular cross-section. The bag stack is loaded into the recess.

### BRIEF DESCRIPTION OF THE DRAWINGS

FIG. 1 is an exploded rear view of the present invention showing installation of the bag stack into the recess of the housing and also showing a stack of bag refills.

FIG. 2 is a front view of the present invention.

The following callouts as to the elements can be a useful guide in referencing the element numbers of the drawings.
20 Housing
21 Frame
22 Strap Connection
23 Recess
24 Recess Sidewall
25 Battery Door
26 Battery Door Screw
27 Strap Connection Opening
31 Pedometer
40 Vessel
41 Flask Wall
42 Flask Lid
43 Flask Ridge
50 Dispenser
51 Dispenser Door
52 Dispenser Door Opening Edge
53 Dispenser Door Opening
54 Latch Protrusion
55 Latch
56 Latch Catch
57 Dispenser Door Bolt
58 Dispenser Door Hinge Pivot
59 Dispenser Door Hinge Mount
61 Bag Protrusion
62 Wrapper Opening Edge
63 Wrapper Opening
64 Wrapper
65 Bag
66 Bag Edge
67 Refills
68 Bag Corner
69 Bag Stack

### DETAILED DESCRIPTION OF THE PREFERRED EMBODIMENT

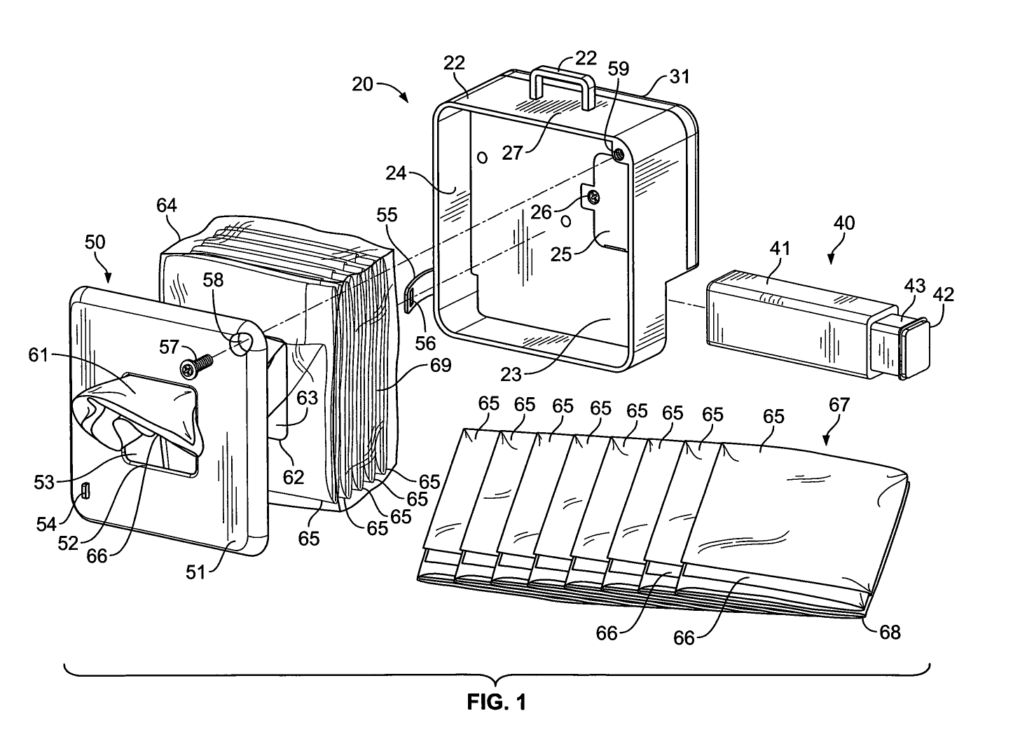

As seen in FIG. 1, the present invention generally includes a housing 20 having a frame 21. The frame 21 further includes a strap connection 22 at an upper surface of the frame 21. The frame 21 is preferably made of a plastic injection molded member. The strap connection 22 extends above a top surface of the frame 21. The strap connection 22 further includes a generally rectangular strap connection opening 27. The strap connection 22 can be formed as a loop with a pair of connections, namely a left connection and a right connection with a horizontal strap connection member bridging between the left connection member and the right connection member. The left connection member is connected to the left connection and the right connection member is connected to the right connection. The frame is shown as a rounded rectangular or square piece, however it can also be made in other shapes. However, the square shape is the preferred shape. Preferably, a strap is connected to the strap connection 22.

The back side or rear side of the frame 21 has a recess 23. The recess 23 extends into the frame 21 such that the recess 23 takes up approximately half of the thickness of the frame 21. The frame 21 is preferably segmented in approximately half of its thickness such that it has a rear portion forming a recess 23 and a front portion for housing a pedometer 31 and vessel 40.

The recess 23 has a recess sidewall that is perpendicular to the recess internal wall. The recess internal wall forms a partition between the pedometer and the dispenser. The recess sidewall extends outwardly. The pedometer 31 may have a battery door 25 for changing batteries to the pedometer. The pedometer 31 may also have a battery door screw 26 for securing the battery door 25 to the recess internal wall. The battery door screw preferably requires a tool for retaining a portion of the battery door to the recess internal wall. The pedometer 31 is preferably mounted to the front side of the frame 21 and can be made modular so that the pedometer 31 can be removed from the frame.

A vessel 40 can be made in rectangular form with a plurality of flask wall 41 bounding the shape of the vessel. The vessel is preferably formed as a flask. The vessel can hold a liquid or gel such as hand sanitizer or soap or moisturizer for cleaning hands of a user. The flask also has a flask lid 42 for securing contents within the flask. The flask lid preferably conforms to a shape of the frame 21 such that the flask lid 42 does not extend beyond a profile of the frame 21. The flask lid 42 preferably additionally includes a flask ridge 43 which is a grip that a user can use for pulling open a pressfit flask lid 42. The vessel 40 preferably also includes a sliding grip so that a user can slide the vessel from the frame 21. Although the vessel 40 is aligned into a slot of the frame, the vessel can be used while being retained by a slot of the frame 21. Alternatively, the vessel can also be used while free from the frame 21.

The recess 23 provides space for a dispenser 50. The dispenser 50 dispenses bags in a bag stack 69. The dispenser 50 has a dispenser door 51. The dispenser door 51 preferably has rounded edges and rounded corners so that it matches the profile of the frame 21. The dispenser door 51 is preferably plastic injection molded. The dispenser door 51 further includes a dispenser door opening edge 52 that goes around a dispenser door opening 53. The dispenser door opening 53 is preferably square, and the dispenser door 51 is also preferably square. The dispenser door opening 53 allows a bag to be removed from the dispenser 50.

The dispenser door 51 is secured to the frame 21 so that the recess 24 is covered. The dispenser door 51 can be swivel mounted to the frame 21. The frame 21 can have a latch 55 that has a latch catch 56 disposed on an end of the latch 55. The latch catch 56 can be formed as a slot opening for engaging with a latch protrusion 54 that is formed on an outside surface of the dispenser door 51. Preferably, the latch protrusion 54 extends normally away from a surface of the dispenser door 51. A user can press the latch with latch catch 56 onto the latch protrusion 54, or a user can unlatch the latch from the latch catch 56 to disengage the latch catch from the latch protrusion 54. The latch is preferably made of an elastomeric flexible strip of plastic. The latch protrusion 54 is preferably rigid and made of the same material as the dispenser door 51. The latch protrusion 54 is preferably integral to the dispenser door 51.

The dispenser door 51 can be swivel mounted to the frame 21. The dispenser door bolt 57 can pass through a dispenser door hinge pivot 58. The dispenser door hinge pivot 58 is formed as an opening in the dispenser door 51. The dispenser door hinge pivot 58 is preferably formed as an opening in a corner of the dispenser door 51. The dispenser door hinge pivot 58 can be a circular opening passing through the thickness of the dispenser door 51. The dispenser door 51 can be mounted to the dispenser door hinge mount 59. The dispenser door hinge mount 59 is a threaded hole formed on the frame, preferably on a corner edge of the recess sidewall 24. The dispenser door bolt 57 passes through the dispenser door hinge pivot 58 and engages to the dispenser door hinge mount 59 to retain the dispenser door 51 in pivot connection to the frame 21.

The bags 65 can be removed one at a time from the dispenser through the dispenser door opening 53. The bag has a bag protrusion 61 during removal of the bag from the dispenser 50 because the bag is being pulled through the dispenser door opening 53. The bags 65 are held in a wrapper 64. The wrapper 64 preferably has a wrapper opening 63 through which the bags 65 can be removed. The wrapper opening 63 also includes a wrapper opening edge 62. The wrapper opening 63 is preferably square and of a slightly larger size than the dispenser door opening 53. The wrapper opening 63 preferably matches the size and shape of the dispenser door opening 53. The bag can be a plastic bag, paper bag or other type of material commonly used for bags. The bags are preferably folded in a stack as a bag stack 69. Each of the bags has four bag corners 68. When the installed bag stack 69 is consumed, a user can unlatch the latch 55 and swivel open the dispenser door 51 so that the user can install a refill 67. The refill stack is not installed with the installed bag stack 69. The bags 65 preferably have a bag edge 66 that are accessible from the dispenser door opening 53. A user can grip the bag edge 66 to unfurl the bag 65 as a partial bag protrusion 61 through the dispenser door opening 53. The user does not need to open the dispenser door 51 to obtain the bags. The bags 65 can be tissues or paper towels or other sheet shaped planar items commonly dispensed from a sheet dispenser.

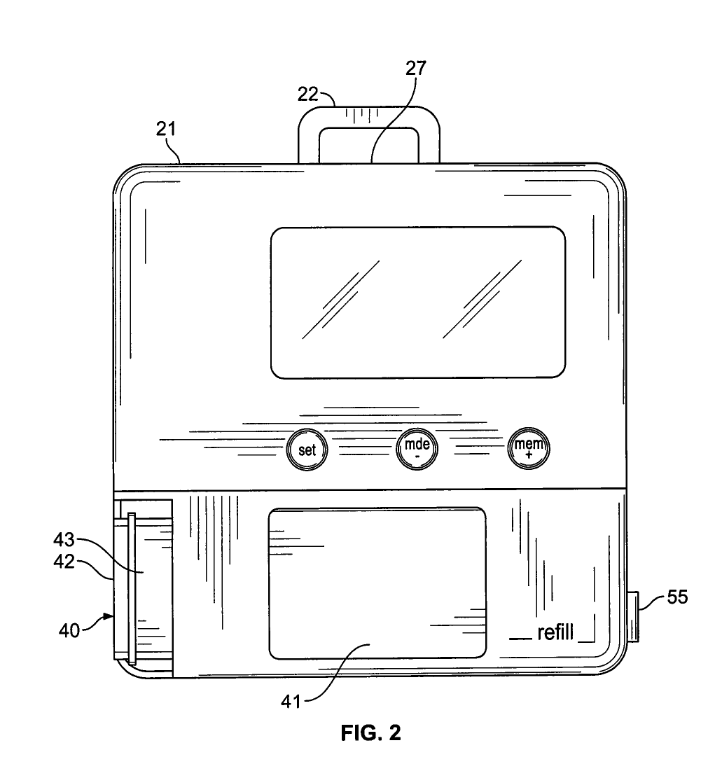

As seen in FIG. 2, the pedometer preferably has a set button, a mode button and a memory button for operating different functions of the pedometer. The set button can be on the left and the memory button can be on the right with the mode button in the middle. The mode button can double as a minus for menu navigation or adjustment of parameters and the memory button can double as a plus for menu navigation or adjustment of parameters. The pedometer control buttons can be made as round buttons located below a monochrome liquid crystal display screen. On the face of the pedometer dispenser, the vial can be seen through a vial window so that a user can see fluid quantity remaining in the vial vessel. A refill line can be displayed to remind the user to refill the vial vessel container.

The pedometer dispenser can be connected to a dog walking leash using the strap connection. A strap can connect to a dog leash handle for example. The pedometer dispenser can also be strap connected to a belt loop or belt of a user. Additionally, the pedometer dispenser could be used as a keychain.

The foregoing describes the preferred embodiments of the invention and modifications may be made without departing from the spirit and scope of the invention as set forth in the following claims.

1. A pedometer dispenser comprising:
a. a housing having a frame;
b. a pedometer mounted to the frame;
c. a recess formed on the frame;
d. a dispenser door mounted to the frame, wherein the dispenser door covers the recess, wherein the dispenser door has an opening formed on a surface of the dispenser door;
e. a dispenser retained within the recess.

2. The pedometer dispenser of claim 1, wherein the dispenser occupies a rear portion of the frame and wherein the pedometer occupies at least a portion of a front portion of the frame.

3. The pedometer dispenser of claim 1, wherein the pedometer dispenser is bounded between the dispenser door and the pedometer.

4. The pedometer dispenser of claim 1, further comprising a latch connected to the frame, wherein the latch is configured to latch onto the dispenser door to form a latch connection between the frame and the dispenser door.

5. The pedometer dispenser of claim 1, further comprising a swivel connection formed between the frame and the dispenser door.

6. The pedometer dispenser of claim 1, further comprising a recess sidewall extending from the frame, wherein the recess sidewall bounds the recess.

7. The pedometer dispenser of claim 1, further comprising a battery door for accessing the pedometer, wherein the battery door is located within the recess.

8. The pedometer dispenser of claim 1, further comprising a flask that is slidingly mounted to the frame, wherein the flask is configured to hold a liquid or gel and wherein the flask can be removed from the frame, wherein the flask has a flask lid that attaches to the flask.

9. The pedometer dispenser of claim 8, wherein the flask has a rectangular cross-section.

10. The pedometer dispenser of claim 1, further comprising a bag stack loaded into the recess.

11. The pedometer dispenser of claim 10, wherein the dispenser occupies a rear portion of the frame and wherein the pedometer occupies at least a portion of a front portion of the frame.

12. The pedometer dispenser of claim 10, wherein the pedometer dispenser is bounded between the dispenser door and the pedometer.

13. The pedometer dispenser of claim 10, further comprising a latch connected to the frame, wherein the latch is configured to latch onto the dispenser door to form a latch connection between the frame and the dispenser door.

14. The pedometer dispenser of claim 10, further comprising a swivel connection formed between the frame and the dispenser door.

15. The pedometer dispenser of claim 10, further comprising a recess sidewall extending from the frame, wherein the recess sidewall bounds the recess.

16. The pedometer dispenser of claim 10, further comprising a battery door for accessing the pedometer, wherein the battery door is located within the recess.

17. The pedometer dispenser of claim 10, further comprising a flask that is slidingly mounted to the frame, wherein the flask is configured to hold a liquid or gel and wherein the flask can be removed from the frame, wherein the flask has a flask lid that attaches to the flask.

18. The pedometer dispenser of claim 17, wherein the flask has a rectangular cross-section.
